(19) United States
(12) Patent Application Publication
(10) Pub. No.: US 2021/0101396 A1
(43) Pub. Date: Apr. 8, 2021

(54) PRINTHEAD ROTATORS

(71) Applicant: Hewlett-Packard Development Company, L.P., Spring, TX (US)

(72) Inventors: Michael Scott Carson, Vancouver, WA (US); Karsten N. Wilson, Corvallis, OR (US); Jordan Wilson, Corvallis, OR (US)

(73) Assignee: Hewlett-Packard Development Company, L.P., Spring, TX (US)

(21) Appl. No.: 16/500,346

(22) PCT Filed: Apr. 7, 2017
(86) PCT No.: PCT/US2017/026533

§ 371 Date: Oct. 2, 2019

(51) Int. Cl. B41J 29/38; B41J 29/13; B41J 29/42

(52) U.S. Cl. CPC B41J 29/38; B41J 29/42; B41J 29/13

(57) ABSTRACT

In example implementations, a printhead rotator for rotating printheads is provided. The apparatus includes a housing and a lid coupled to the housing. A rotator assembly that holds a printhead is enclosed by the housing and the lid. The printhead in the rotator assembly is rotated by a motor coupled to the rotator assembly at a predefined rate. A timer display and a color indicator is also coupled to the housing.

### BACKGROUND

Printers or printing devices can apply ink on a print medium to generate an image. The ink may be any type of liquid that includes dyes, or pigments, that can be ejected onto a print medium to form an image. Printers can use different types of ink to print, including toner ink, UV curing inks, and the like. Some inks can use a warm up time to prevent banding. For example, the printing device may operate by printing using the ink for several minutes.

### BRIEF DESCRIPTION OF THE DRAWINGS

FIG. 1 is a block diagram of an example printhead rotator of the present disclosure;

FIG. 2 is an isometric view of an example printhead rotator that holds a plurality of printheads of the present disclosure;

FIG. 3 is an isometric view that illustrates an example of the rotator assembly removed from an enclosure assembly of the present disclosure;

FIG. 4 is an exploded isometric view of the example rotator assembly of the present disclosure;

FIG. 5 is an exploded isometric view of the example enclosure assembly of the present disclosure;

FIG. 6 is a side view of the enclosure assembly of the present disclosure; and

FIG. 7 is a flow diagram of an example method for rotating a printhead of the present disclosure.

### DETAILED DESCRIPTION

The present disclosure discloses an apparatus for rotating printheads for pigment mixing. Some inks, such as inks contained in pens, or printheads, used in a thermal inject print technology, can have print defects if the inks settle and are not used for long periods of time. One example print defect may be banding that can be noticeable in large area-fill prints and caused by pigment settling in the ink.

One solution to avoid these print defects may be to use a warm up time. For example, the printing device may operate by printing using the ink for several minutes. However, such an operation may consume an unacceptable amount of ink and paper.

The present disclosure provides a printhead rotator that is designed as a small table-top or shelf mounted unit that can process several printheads to prevent pigment settling. The printhead rotator may operate at a low rotations per minute (RPM) that is proven to be effective to mitigate pigment settling. The printhead rotator may have individual timers for each slot permitting tracking of individual printhead rotation time and to ensure that each printhead is rotated sufficiently to mix the settled pigment.

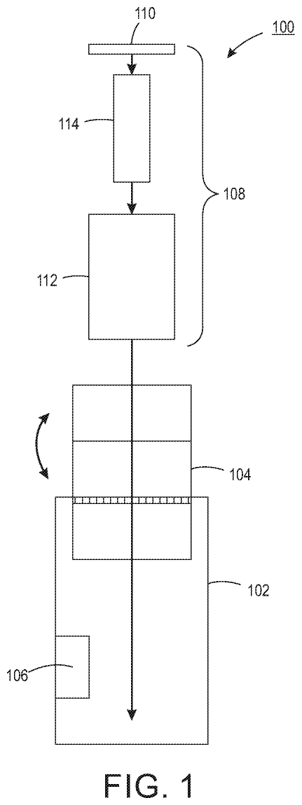

FIG. 1 illustrates a block diagram of a front view of an apparatus 100 of the present disclosure. The apparatus 100 may be an example of a single printhead rotator. For example, the apparatus 100 may include a housing 102, a movable lid 104 coupled to the housing 102 and a motor 106. In one implementation, the apparatus 100 may also include a rotator assembly 112 having a removable cover 110. The rotator assembly 112 may hold a printhead 114 that is secured with the removable cover 110. The housing 104, the movable lid 104, the rotator assembly 112 and the removable cover 110 may be fabricated from a metal (e.g., a sheet metal), a plastic, or a combination of different materials (e.g., metal and plastic).

The printhead 114 may include ink that is used for a printer, or any type of printing device (e.g., a thermal inject printer, a multi-function device (MFD), a three-dimensional (3D) printer, and the like). If the printhead 114 is left in a stationary position, the ink may settle causing undesirable print defects. The apparatus 100 of the present disclosure may rotate the printhead 114 such that the settled ink is mixed back into solution to provide an acceptable print quality when the printhead 114 is used within a printer.

In one example, the rotator assembly 112 may be removably coupled to the motor 106 inside of the housing. The motor 106 may be set to rotate the rotator assembly 112 inside of the housing 102 around a horizontal axis (e.g., an axis that runs across a width of the housing 102) at a predefined rate. The predefined rate may be any rotations per minute (RPM) that provides sufficient mixing to suspend the settled pigment or ink within the printhead 114. In one implementation, the predefined rate may be between 5-15 RPMs. In one implementation, the predefined rate may be approximately 7-8 RPMs. For example, the predefined rate may be approximately 7.8 RPMs.

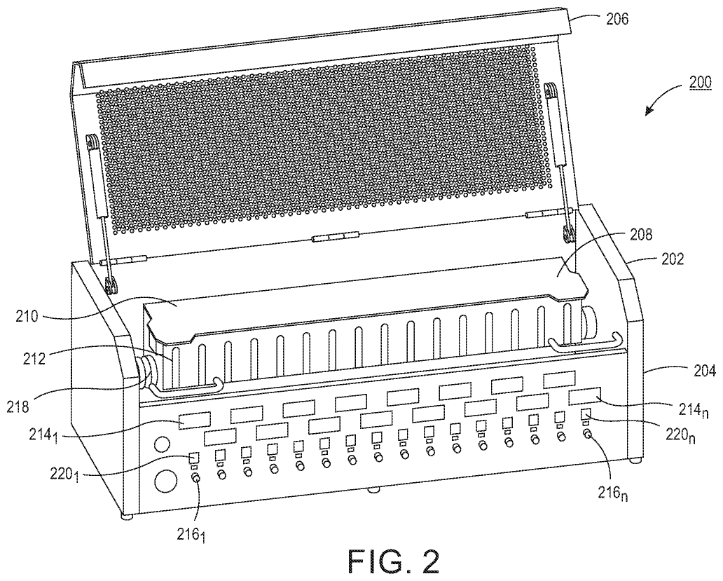

The apparatus 100 may be expanded to rotate a plurality of the printheads 114, as discussed below. In addition, the apparatus 100 may include additional features such as a timer display, a timer display reset, a color indicator, a position sensor, a lid sensor to ensure that the movable lid 104 is closed during operation, and the like. Details of these additional features are discussed below and illustrated in further detail in FIGS. 2-6.

FIG. 2 illustrates an isometric view of an apparatus 200 of the present disclosure. The apparatus 200 is one example that holds a plurality of the printheads 114. In one implementation, the apparatus 200 may include an enclosure assembly 202 comprising a housing 204 and a movable lid 206. The movable lid 206 may be perforated for viewing to allow a user to look into the enclosure assembly 202 when the movable lid 206 is in a closed position. The apparatus 200 may also include a rotator assembly 208 that comprises a plurality of printhead slots 212 aa removable cover 210.

In one implementation, the enclosure assembly 202 includes a motor 218 that is removably coupled to the rotator assembly 208. In one example, the motor 218 may be set to rotate the rotator assembly 208 inside of the enclosure assembly 202 around a horizontal axis (e.g., an axis that runs across a width of the housing 102) at a predefined rate. The predefined rate may be any rotations per minute (RPM) that provides sufficient mixing and prevents settling of the pigment or ink within the printhead 114. In one implementation, the predefined rate may be between 5-15 RPMs. In one implementation, the predefined rate may be approximately 7-8 RPMs. For example, the predefined rate may be approximately 7.8 RPMs.

As noted above, the apparatus 200 may also include additional features to help provide information to a user regarding how long the printhead 114 has been rotating and what color is located within each slot of the plurality of printhead slots 212. For example, the enclosure assembly 202 may include a plurality of timer displays 214₁ to 214ₙ (also referred to herein individually as a timer display 214 or collectively as timer displays 214). Each one of the timer displays 214 may include a chronometer that tracks an amount of time.

In one example, the timer displays 214 may display time in a format of two digits each for hours; minutes and second (e.g., HH:MM:SS). In another example, the timer displays 214 may display time in a format of hours and decimal hours. For example, the timer display 214 may have five hour digits and a single decimal hour digit (e.g., HHHHH.H).

In one implementation, each timer display 214₁ to 214ₙ may have a timer display reset 220₁ to 220ₙ (also referred to herein individually as a timer display reset 220 or collectively as timer display resets 220). In one example, the timer display reset may be a physical button that resets a respective timer display 214 to all zeros.

In another example, the timer display reset 220 may be automated. For example, the timer display reset 220 may include a sensor and an infrared transmitter. When a printhead 114 is removed from between the sensor and the infrared transmitter, the sensor may detect a light or signal from the infrared transmitter. When the sensor detects the light from the infrared transmitter, the sensor may transmit a signal to reset the respective timer display 220.

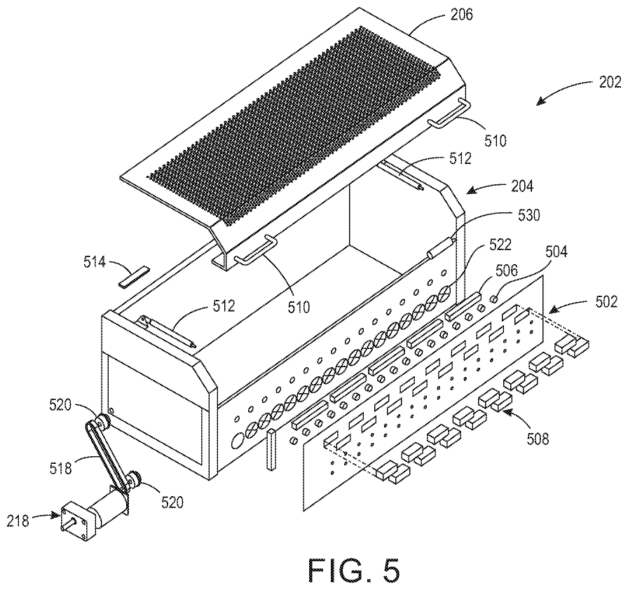

The enclosure assembly 202 may also include a plurality of color indicators 216₁ to 216ₙ (also referred to herein individually as a color indicator 216 or collectively as color indicators 216). In one implementation, the color indicator 216 may be a mechanical wheel that is illustrated in further detail in FIG. 5. The color indicator 216 may indicate what color is associated with the printhead 114 in a particular slot of the plurality of printhead slots 212.

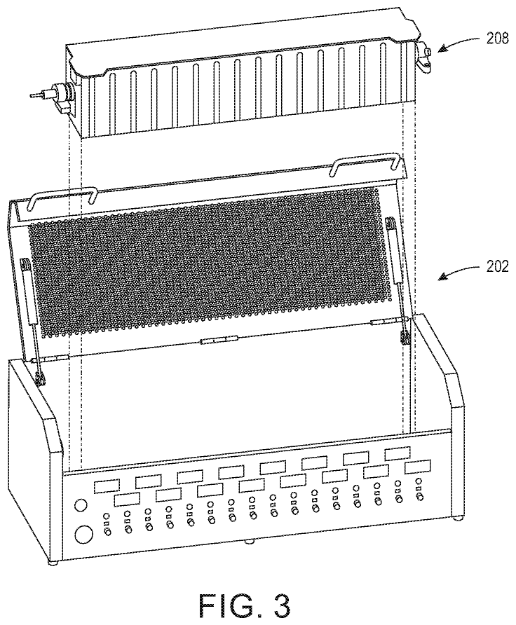

FIG. 3 illustrates an isometric view of the rotator assembly 208 removed from the enclosure assembly 202. The rotator assembly 208 may be removed from the enclosure assembly 202 for maintenance, cleaning, adjustments to the motor 218, and the like. The rotator assembly 208 may also be removed for easier transport of the printheads 114 as the entire apparatus 100 may be quite heavy.

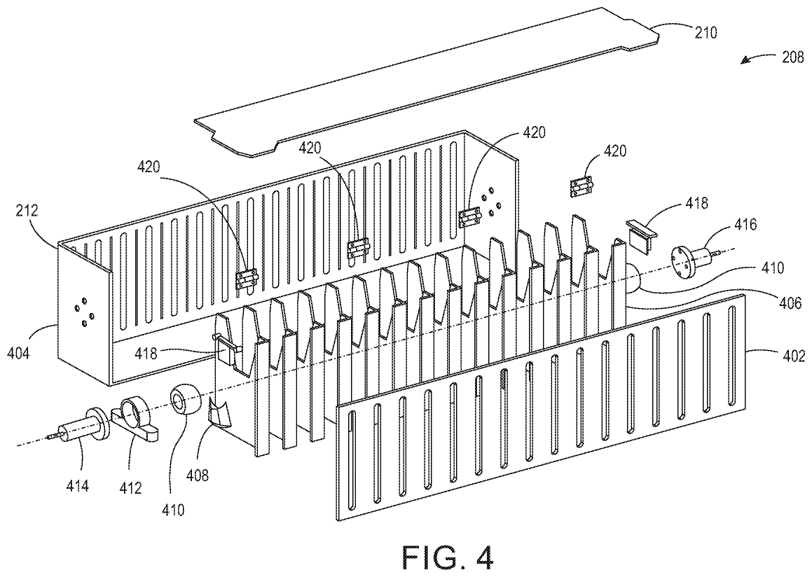

FIG. 4 illustrates an exploded isometric view of one example of the rotator assembly 208. In one implementation, the plurality of printhead slots 212 may include a front mounting plate 402, a back mounting plate 404 and a plurality of pocket separators 406. The printheads 114 may be inserted into each one of the pocket separators 406. The number of timer displays 214, timer display resets 220 and color indicators may be equivalent to a number of pockets in the plurality of pocket separators 406. FIG. 4 illustrates 16 pockets, but it should be noted that any number of pockets to hold any number of printheads 114 may be used.

In one implementation, the number of pockets in the plurality of pocket separators 406 may be a function of a number of different colored printheads 114 used by a type of printer. For example, if a particular type of printer users a large number of different colors and multiple printheads 114 for each color, the number of pockets in the plurality of pocket separators 406 may be increased to ensure that a sufficient number of printheads 114 for replacement can be adequately rotated before use.

In one example, the dimensions of each pocket of the plurality of pocket separators 406 may be equivalent to dimensions associated with a printhead 114. The dimensions may include a width, a height and a depth. The dimensions may be associated with the printheads 114 that are still enclosed or sealed within a bag.

In other implementations, the plurality of pocket separators 406 may include a small tab or tabs at a bottom of the plurality of pocket separators 406. In other words, the plurality of pocket separators 406 may be fabricated without fully divided separate pockets as illustrated by example in FIG. 4.

The rotator assembly 208 may also include a location actuator 408. The location actuator 408 may be used to detect an orientation of the rotator assembly 208 within the assembly enclosure 202. For example, when the motor 218 is stopped by a user, the motor 218 may continue to rotate the rotator assembly 208, or finish a current rotation, until the rotator assembly 208 is in a pre-defined position. The pre-defined position may allow a user to easily remove the removable cover 208 and insert or remove the printheads 114. In one example, the pre-defined position may be having the removable cover 208 vertically upwards. In another example, the pre-defined position may be having the removable cover 208 slightly tilted towards the user (e.g., approximately 20 degrees relative to a vertical axis).

The rotator assembly 208 may include bearings 410 on each side of the rotator assembly 208. On one side, a drive shaft stub 416 (e.g., a non-drive shaft) may be coupled to a respective bearing 410. On the opposite side of the drive shaft stub 416, the bearing 410 may be coupled to a bearing block 412 and a drive shaft stub 414. The drive shaft stub 414 may be removably coupled to the motor 218 to rotate the rotator assembly 208.

The rotator assembly 208 may include latches 418 to latch the removable cover 210 to the plurality of printhead slots 212. In one example, the removable cover 210 may be fabricated from metal and the latches 418 may be magnetic to secure the removable cover 210. In another example, the latches 418 may be mechanical and mechanically secure the removable cover 210 (e.g., a latch, a slot, a sliding lever, and the like). A plurality of hinges 420 may also be coupled to the pocket separators 406 to allow the pocket separators 406 to slightly rotate inside of the rotator assembly 208.

FIG. 5 illustrates an exploded isometric view of an example enclosure assembly 202 of the present disclosure. In one implementation, the enclosure assembly 202 may include the movable lid 206 that is coupled to the housing 204. The movable lid 206 may be coupled to the housing 204 via a hinge 514 and gas springs 512. The gas springs 512 may allow the movable lid 206 to remain in an open position without being held by a user. The movable lid 206 may also include handles 510 for ease of operation.

In one implementation, the enclosure assembly 202 may include terminal blocks 506. The terminal blocks 506 may provide the electrical power and circuitry to operate chronometers 508 that are within the timer displays 214.

In one example, the printheads 114 maybe rotated for a minimum predefined amount of time (e.g., approximately 2 hours). In one implementation, the movable lid 206 may be locked until one of the timer displays 214 reaches the minimum predefined amount of time to ensure that the printhead 114 is rotated sufficiently before use.

The enclosure assembly 202 may also include color wheels 522. Each one of the color indicators 216 may include a color wheel 522. The color wheel 522 may have portions of the wheel in different colors. For example, for printheads 114 that may be a cyan, magenta, yellow and black color, the color wheel 522 may have portions that are colored in cyan, magenta, yellow and black. It should be noted that any colors may be used and the above is provided as an example.

A desired color of the color wheel 522 may be exposed through a corresponding opening in a front plate 502 of the enclosure assembly 202. The color wheel 522 may have a knob that can be used to rotate the color wheel 522 to change the color that is exposed through the corresponding opening in the front plate 502. This may help a user to identify what color printhead 114 is in each one of the plurality of printhead slots 212. For example, the color of the printheads 114 may be indistinguishable from one another inside of the packaging.

In one example, the front plate 502 may also have cut outs for each one of the timer displays 214 and timer display resets 220 when a physical button is used for the timer display resets. The front plate 502 may be coupled to a front side of the housing 204 to cover the terminal blocks 506 and the color wheels 522.

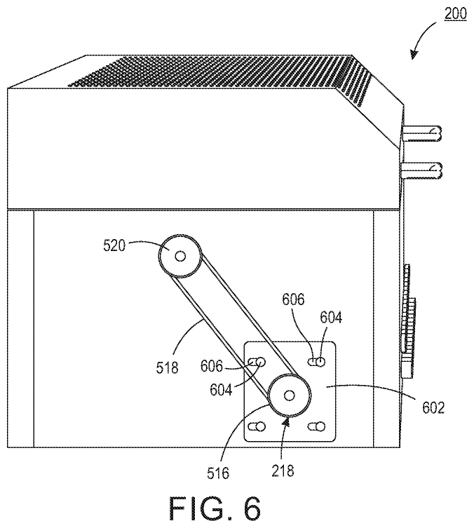

In one example, the motor 218 may be coupled to a drive belt 518 and pullets 520. The drive belt 518 may be rotated by the motor 218 and around the pullets 520 that are spaced apart from one another to provide tension to the drive belt 518. A more detailed illustration of the motor 218 is illustrated in FIG. 6 and discussed below.

The enclosure assembly 202 may also include a sensor 530 to detect when the movable lid 206 is closed. In one implementation, the sensor 530 may be communicatively coupled to the motor 218. The sensor 530 may be configured to stop, or prevent, operation of the motor 218 when the sensor 530 detects that the movable lid 206 is not closed. For example, the sensor 530 may detect when a surface of the movable lid 206 is in contact with the sensor 530 indicating that the movable lid 206 is in a closed position.

The sensor 530 may cause the motor 218 to stop operating if the movable lid 206 is opened (e.g., moved away from the sensor 530) during operation of the motor 218.

FIG. 6 illustrates a side view of the enclosure assembly 202 and the motor 218. In one implementation, one of the pullets 520 may be coupled to a pull block 602 and the other pullet 520 may be coupled directly to the housing 204. The pull block 602 may also be coupled to the motor 218 inside of the housing 204. The pull block 602 may include slots 606 that allow for horizontal movement of the pull block 602. The pull block 602 to may be positioned to provide a desired amount of tension on the drive belt 518 and set by screws 606 that are inserted into the corresponding slots 606. The desired amount of tension on the drive belt 518 may be used to control the rotation of the rotator assembly 208 at the desired RPMs, as discussed above.

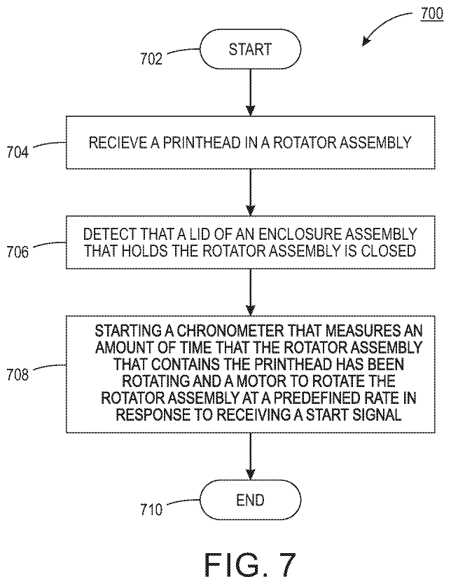

FIG. 7 illustrates a flow diagram of an example method 700 for rotating a printhead. In one example, the method 700 may be performed by the apparatus 100 or 200 described above.

At block 702, the method 700 begins. At block 704, the method 700 receives a printhead in a rotator assembly. For example, the printhead may be inserted into a pocket of the rotator assembly. In some examples, a plurality of printheads may be inserted into different pockets of a plurality of pockets of the rotator assembly.

At block 706, the method 700 detects that a lid of an enclosure assembly that holds the rotator assembly is closed. For example, the printheads may be secured inside of the rotator assembly by a removable cover. The lid of the enclosure assembly may then be closed to secure the entire rotator assembly within the enclosure assembly.

In one implementation, the enclosure assembly may not operate the motor until the lid is closed. For example, the enclosure assembly may have a sensor to detect when the lid is in an open position or in a closed position.

At block 708, the method 700 starts a chronometer that measures an amount of time that the rotator assembly that contains the printhead has been rotating and a motor to rotate the rotator assembly at a predefined rate in response to receiving a start signal. For example, when the motor of the enclosure assembly is started the chronometer may also be started. Some chronometers may continue from a time that was previously displayed, but no reset. Other chronometers may begin measuring the amount of time from zero.

In one implementation, the motor may operate at a predefined rate to rotate the rotator assembly around a horizontal axis (e.g., an axis that runs across a width of the housing). In one implementation, the predefined rate may be between 5-15 RPMs. In one implementation, the predefined rate may be approximately 7-8 RPMs. For example, the predefined rate may be approximately 7.8 RPMs.

In one implementation, the motor may be stopped. For example, a user may press a start/stop button to send a stop signal to stop operation of the motor or the enclosure assembly may detect that the lid has been opened to generate the stop signal to the motor. In response to the stop signal, the motor may finish a current rotation of the enclosure assembly until the rotator assembly is in a pre-defined position. For example, the pre-define position may be approximately 20 degrees (e.g., relative to a vertical axis that represents 0 degrees) towards a front of the enclosure assembly.

In one example, a printhead may be removed and a reset signal may be received for a respective chronometer. For example, a physical button may be pressed or a sensor may detect a light signal from an infrared transmitter when the printhead is removed. The reset signal may cause the respective chronometer to reset to zero. The user may insert a different printhead or close the lid and continue operation of the motor to rotate the printheads in the rotator assembly. At block 710, the method 700 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A printhead rotator, comprising:
a housing;
a movable lid coupled to the housing;
a rotator assembly that holds a printhead and is secured by a removable cover coupled to the rotator assembly, wherein the rotator assembly is enclosed by the housing and the lid; and
a motor coupled to the rotator assembly to rotate the rotator assembly that holds the printhead inside of the housing around a horizontal axis at a predefined rate.

2. The printhead rotator of claim 1, comprising:
a timer display coupled to the housing.

3. The printhead rotator of claim 1, comprising:
a color indicator coupled to the housing, wherein the color indicator comprises a rotatable wheel and an opening that reveals a portion of the rotatable wheel, wherein the rotatable wheel comprises a plurality of different colors.

4. The printhead rotator of claim 1, wherein the rotator assembly comprises a position location sensor to stop rotation in at a predefined position when the motor is turned off.

5. The printhead rotator of claim 1, comprising:
a sensor coupled to the lid to detect when the lid is opened, wherein the sensor sends a signal to stop the motor.

6. The printhead rotator of claim 1, comprising:
a timer display reset.

7. The printhead rotator of claim 6, wherein the timer display reset comprises a manual button.

8. The printhead rotator of claim 6, wherein the timer display reset comprises a sensor and an infrared transmitter, wherein the sensor sends a signal to reset the timer display in response to detecting the infrared transmitter.

9. A printhead rotator, comprising:
an enclosure assembly;
a rotator assembly couple to an interior of the enclosure assembly, the rotator assembly comprising a plurality of printhead slots that each receive a printhead and are secured by a removable cover coupled to the rotator assembly; and
a motor coupled to the rotator assembly to rotate the rotator assembly inside of the housing around a horizontal axis at a predefined rate.

10. The printhead rotator of claim 9, comprising:
a plurality of timer displays coupled to the housing, wherein the each one of the plurality of timer displays is coupled to a respective chronometer.

11. The printhead rotator of claim 9, wherein the enclosure assembly comprises a lid with a perforated viewing window.

12. The printhead rotator of claim 9, comprising:
a plurality of color indicators coupled to the housing; wherein each one of the plurality of timer displays and each one of the plurality color indicators is associated with a respective one of the plurality of printhead slots, wherein the plurality of color indicators each comprises a mechanical indicator.

13. A method comprising:
receiving a printhead in a rotator assembly;
detecting that a lid of an enclosure assembly that holds the rotator assembly is closed; and
starting a chronometer that measures an amount of time that the rotator assembly that contains the printhead has been rotating and a motor to rotate the rotator assembly at a predefined rate in response to receiving a start signal.

14. The method of claim 13, wherein the predefined rate comprises approximately 5 rotations per minute (RPM) to 15 RPM.

15. The method of claim 13, comprising:
receiving a stop signal;
rotating the rotator assembly approximately 20 degrees towards a front of the enclosure assembly;
receiving a reset signal for the chronometer; and
resetting the chronometer to zero.
